(19) United States
(12) Patent Application Publication
(10) Pub. No.: US 2025/0168599 A1
(43) Pub. Date: May 22, 2025

(54) APPARATUS, METHOD, AND SYSTEM

(71) Applicant: Piis Inc., Tokyo (JP)

(72) Inventors: Shimpei MORITA, Tokyo (JP); Tatsuya OGAWA, SAITAMA (JP)

(73) Assignee: Piis Inc., Tokyo (JP)

(21) Appl. No.: 19/035,116

(22) Filed: Jan. 23, 2025

Related U.S. Application Data
(63) Continuation of application No. PCT/JP2023/024453, filed on Jun. 30, 2023.

(30) Foreign Application Priority Data
Aug. 19, 2022 (JP) 2022-131333

(51) Int. Cl. H04W 4/029

(52) U.S. Cl. CPC H04W 4/029

(57) ABSTRACT

An apparatus includes processing circuitry configured to: acquire location information of a plurality of users; extract, from the location information of the plurality of users, a user who has visited a predetermined spot during a predetermined period; and generate, as activities-on-that-day data, data on where the user has been during preceding and subsequent periods per a predetermined unit time relative to a timing when the spot has been visited by the user who has visited the predetermined spot based on the location information of the extracted user.

### CROSS-REFERENCE TO RELATED APPLICATION

This application is a continuation of International Application No. PCT/JP2023/024453, filed Jun. 30, 2023, which claims priority to Japanese Patent Application No.2022-131333, filed Aug. 19, 2022, the entire contents of each are incorporated herein by reference.

### FIELD

The present disclosure relates to an apparatus, a method, and a system for acquiring data on activity of a user based on location information of the user and information on a spot visited by the user.

### BACKGROUND

With the recent proliferation of smartphones, location information of users can easily be acquired. The ability to acquire location information of a plurality of users would make it possible to visualize the flow of people and analyze what type of people gather at any particular place as well as where people move from and to. Furthermore, analysis can be made based on the commonality or the like of places where people have visited to help regional development, cultural preservation, businesses, and the like.

For example, a conventional information providing device is disclosed that allows effective reuse of past records of traces and activities of a user.

However, the conventional information providing device only determines similarities between users of activities, each of which has been recorded by a user independently, and it has been difficult to grasp a service expected by the user who has visited a particular facility or region.

An object of the present disclosure is to grasp a service expected by a user who has visited a particular facility or region.

### BRIEF DESCRIPTION OF DRAWINGS

FIG. 1 is a diagram illustrating an example of a functional configuration of a server 10 according to a first embodiment of the present disclosure.

FIG. 2 is a diagram illustrating an example of a data configuration of user information DB 1021.

FIG. 3 is a diagram illustrating an example of a data configuration of spot information DB 1022.

FIG. 4 is a diagram for describing a processing flow of the server 10.

FIG. 5A is a diagram illustrating an arrangement of the spots visited by a user on that day.

FIG. 5B is a diagram for describing detection of the location-on-that-day information of the user.

FIG. 6 is a diagram illustrating an example of clustering made based on the commonality of the spots visited by the user.

FIG. 7 is a diagram illustrating an example of clustering made by factoring in a dwell time, the number of visits, and the like, in addition to the commonality of the spots visited by the user.

FIG. 8A is a radar chart based on the activities-on-that-day data in activity data comparison by a data analyzing section 1034.

FIG. 8B is a radar chart based on the daily-activities data in activity data comparison by the data analyzing section 1034.

FIG. 9 is a diagram for describing detection of the location-on-that-day information of a user according to a modification.

FIG. 10 is a diagram illustrating a hardware configuration of the server 10 of the present disclosure.

FIG. 11 is a diagram illustrating an overall configuration of a system 1 through a network.

FIG. 12 is a diagram illustrating an example of a functional configuration of the server 10 according to a second embodiment.

FIG. 13 is a diagram for describing a processing flow of the server 10 according to the second embodiment.

FIG. 14 is a diagram illustrating an example of a functional configuration of the server 10 according to a third embodiment.

FIG. 15 shows diagrams for describing processing details of the data utilization section 1035.

FIG. 16 is a diagram for describing the first half of a processing flow of the server 10 according to a third embodiment.

FIG. 17 is a diagram for describing the second half of the processing flow of the server 10 according to the third embodiment.

### DETAILED DESCRIPTION

In general, according to one embodiment, an apparatus according to an aspect of the present disclosure comprising processing circuitry configured to: acquire location information of a plurality of users; extract, from the location information of the plurality of users, a user who has visited a predetermined spot during a predetermined period; and generate, as activities-on-that-day data, data on where the user has been during preceding and subsequent periods per a predetermined unit time relative to a timing when the spot has been visited by the user who has visited the predetermined spot based on the location information of the extracted user.

Embodiments of the present disclosure will now be described with reference to drawings. Note that the embodiments described below are not intended to unduly limit the scope of the present disclosure described in the claims. Furthermore, not all configurations described in the embodiments are necessarily essential constituent features of the present disclosure. In all drawings for describing the embodiments, common components are given the same reference signs, and the description will not be repeated.

The recent development of information processing technologies makes it possible to provide well-directed marketing or recommendation when given detailed user information. However, personally targeting a user is considered undesirable from a viewpoint of its effectiveness, public images, difficulty in data collection, and privacy protection. Accordingly, there is a need for aggregated statistical data that is not associated with any individual while still achieving detailed and accurate preference analysis. On the other hand, combining a plurality of different types of data is far from practical due to problems in the rate of generation, accuracy, and exhaustiveness of data, the amount of collected data and costs of collecting and combining the data, usability of data for repurposing, or the like. Considering this, the applicants have conceived of a server 10 as an information processing device of the present disclosure in view of:
the statistical data is desirably generated from a single piece of data as much as possible; and
the statistics are taken by using location information of a user and information on a spot. The configuration of the server 10 will now be described.

### 1. FIRST EMBODIMENT

### 1. Functional Configuration of Server 10

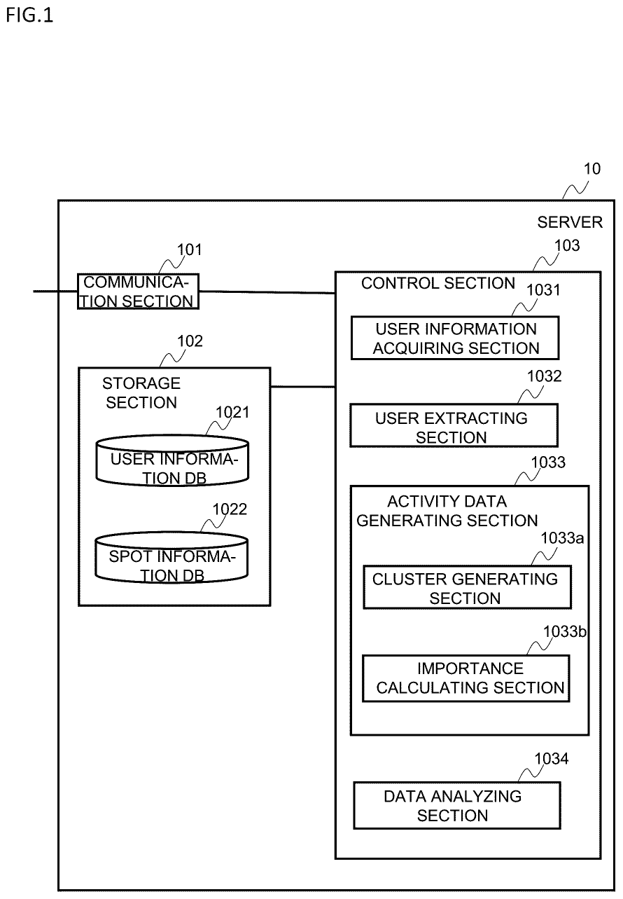

The configuration of the server 10 will now be described in detail. As illustrated in FIG. 1, the server 10 according to the embodiment includes a communication unit 101, a storage unit 102, and a control unit 103. The communication unit 101 performs processing for the server 10 to communicate with other devices. The communication unit 101 subjects a signal generated in the control unit 103 to transmission processing and transmits it to the outside. The communication unit 101 subjects an externally received signal to reception processing and outputs it to the control unit 103.

The storage unit 102 is constituted of, for example, a flash memory and the like, and stores data and programs, which are used by the server 10.

The control unit 103 is implemented by the processor 11 reading a program stored in the storage unit 102 and executing an instruction included in the program. The control unit 103 controls the operation of the server 10. Specifically, for example, the control unit 103 carries out functions as a user information acquiring unit 1031, a user extracting unit 1032, an activity data generating unit 1033, and a data analyzing unit 1034. Each of the functions will now be described.

### (1.1. User Information Acquiring Unit 1031)

The user information acquiring unit 1031 acquires location information of a user and time information through the communication unit 101. The location information of a user is, for example, information of latitude, longitude, and the like. The time information is information of time of a point at which the location information is acquired.

To acquire the location information of a user, information from GPS (Global Positioning System) or the like mounted in a smartphone, a smartwatch, or the like, possessed by the user may be used. A terminal such as a magnetic reader and an IC reader may also be installed, and the location information may be acquired given that the user allows the terminal to read the user's own terminal or the like. Furthermore, the location information that can be obtained from a base station of a communication device such as a cellular phone or the location information that can be obtained from WiFi (Wireless Fidelity (Registered Trademark)) may be acquired.

The user information acquiring unit 1031 may also acquire the location information based on information sent to SNS (Social Networking Service).

As an example, it is desirable that the user information acquiring unit 1031 periodically acquires the location information and the time information from a user at a fixed time interval. The shorter the interval for acquiring the location information of the user, the more desirable it is, because it enables detailed analysis.

On the other hand, when the time interval for acquiring the location information is longer, it is possible to mitigate a load on the system and the network, while it is more likely that a shorter interval enables detailed analysis on activities of the user. Accordingly, the user information acquiring unit 1031 may set a time interval for acquiring the location information of a user in consideration of what is analyzed and a load on the system. Note that the acquisition of the location information and the time information may not occur at a fixed time interval, and it may be stated in the specifications that rearrangement is made at a fixed interval after acquisition.

The user information acquiring unit 1031 stores the location information acquired from a user along with a user ID and the acquired time information in the user information DB 1021. In the server 10, it is desirable that the location information of a user is temporarily stored in the storage unit 102, so that analysis can be performed by using clustering and the like from various viewpoints.

### (1.2. User Extracting Unit 1032)

The user extracting unit 1032 extracts a user who has visited a predetermined spot during a predetermined period (hereinafter, also referred to as a visiting user). Any period may be set for the predetermined period (hereinafter, also referred to as a survey period), and it may be, for example, for one month. The spot refers to a certain place such as a shop and a facility, which can be determined according to the latitude and the longitude. The predetermined spot (hereinafter, also referred to as a survey spot) can be set as appropriate for a survey from a specific shop, a facility, an art museum, or the like. Here, the user extracting unit 1032 may segment a map into meshes in a grid matrix in advance at a predetermined interval (as an example, 125 m interval) and may determine on a mesh-by-mesh basis whether or not a survey spot has been visited. In this case, when a certain mesh is visited, it may be determined that one or more spots included in the mesh have been visited. When a predetermined spot has a large area, for example, as in a large park, there may be a case in which a plurality of meshes are present in one spot. In this case, even when a plurality of meshes in one spot have been visited, it may be determined that the spot has been visited once. The user extracting unit 1032 refers to the user information DB 1021 and the spot information DB 1022 to extract a user who has visited a survey spot during a survey period.

### (1.3. Activity Data Generating Unit 1033)

The activity data generating unit 1033 generates the activities-on-that-day data, which is statistical data on activities of a visiting user on that day, and the daily-activities data, which is statistical data on daily activities. Specifically, the activity data generating unit 1033 acquires location information (hereinafter, also referred to as the location-on-that-day information) on the day when an extracted visiting user has visited a survey spot (hereinafter, also referred to as “that day”). Furthermore, the activity data generating unit 1033 acquires location information (hereinafter, also referred to as the daily-location information) of the extracted user during the survey period (hereinafter, also referred to as “daily”). The activity data generating unit 1033 further includes a cluster generating unit 1033a and an importance calculating unit 1033b.

### (1.3.1. Cluster Generating Unit 1033a)

The cluster generating unit 1033a of the embodiment performs area clustering, in which a cluster that is a classification of users are generated based on location information of a spot visited by a user.

Based on user information acquired from the user extracting unit 1032, the cluster generating unit 1033a grasps which spot the user has checked in, that is, which spot the user has visited.

To determine the user's visit to the spot, for example, the cluster generating unit 1033a matches the location information of the user such as latitude and longitude with location information of the spot such as latitude and longitude and determines the visit when the places coincide.

If exact agreement of location information is required to be deemed as a visit, it may possibly be determined that no spot has been visited by the user. Accordingly, a certain threshold L may be preset, and when the distance between the spot and the user is equal to or less than L, it may be deemed that the user has visited the spot. In this way, an error in location information can be cancelled. Furthermore, as described above, a map may be segmented into meshes in a grid matrix in advance, and it may be deemed that the user has visited a spot in the mesh. Alternatively, it may be determined that the user has visited a spot by using a general algorithm.

When determining the user's visit to the spot, the cluster generating unit 1033a makes a determination given that the location information of the user and that of the spot agree with each other. At this time, a visit may be determined given that the agreement has simply been made, or by using information of temporally continuous agreements, a determination may be made to distinguish “passing by”, “visit”, or “utilization”.

For example, when the user information acquiring unit 1031 acquires location information of a user at a fixed time interval, there may be a case in which even though the location information of the user and that of a spot agree with each other, the user has only passed by the spot instead of visiting the spot. In this case, the passing by may be determined. Furthermore, when the location information of the user and that of a spot agree with each other at or more than a certain number of times that is temporally continuous (first threshold), it may be determined that the spot has been visited. Furthermore, when the location information of the user and that of a spot agree with each other at or more than a certain number of times that is temporally continuous (second threshold) at a spot such as a movie theater, a hot-spring facility, and a theme park, it may be determined that the spot has been utilized. Furthermore, when the location information of the user and that of a spot agree with each other at or more than a certain number of times that is temporally continuous (third threshold), it may be determined that the user has been working at the spot.

In shot, in a temporally continuous manner, it may be determined as follows: “passing by” when the number of times the location information of the user and that of a spot agree with each other is less than the first threshold, “visit” when the first threshold or more and the second threshold or less, “utilization” when the second threshold or more and the third threshold or less, and “working” when the third threshold or more. Each threshold may be set on a spot-by-spot basis.

When the cluster generating unit 1033a determines a user's visit to a spot, how the user travels may be taken into consideration. For example, when acquiring the location information of the user at a fixed time interval, the user information acquiring unit 1031 may estimate a travelling speed according to a travel distance per unit time, from travel distances based on temporally continuous pieces of location information, and determine whether the user has been travelling on foot or by using a mode of transportation such as an automobile or a train. Then, when it is determined that the user has been travelling at least by an automobile, a train, and the like, the user has not visited the spot but only passed through the spot even when the location information of the user and that of the spot agree with each other, so that the cluster generating unit 1033a may be prevented from determining that the user has visited the spot.

For example, in a case in which location information of a user is acquired based on a terminal such as a magnetic reader and an IC reader installed at a spot, the cluster generating unit 1033a may determine that the user has visited the spot given that the user's own terminal has been read by the terminal.

The cluster generating unit 1033a generates a cluster that is a classification of users based on a spot visited by a user. The cluster generating unit 1033a generates clusters, for example, based on the commonality of the spots visited by the user (from the viewpoint of the spot, the commonality of visited users) by using hierarchical clustering, non-hierarchical clustering, known algorithms, or the like. At this time, the cluster generating unit 1033a may define a target number of clusters to be generated as M1 and perform clustering followed by generation of M1 area clusters in descending order of the number of spots and users that are in common.

When performing clustering, the cluster generating unit 1033a may take into account the number of visits for a spot, the clock time of a visit, a dwell time, the commonality of the types of spots, and the like, to generate a cluster. In addition, the cluster generating unit 1033a may take into account a total dwell time, an average dwell time, the number of times the spot has been introduced or cited on a media such as TV, magazines, the Internet, and SNS, a mobile body, and the like, to generate an area cluster.

Furthermore, the cluster generating unit 1033a may assign weights to factors such as the commonality of spots, the number of visits for a spot, the clock time of a visit, a dwell time, the commonality of the types of spots, a total dwell time, an average dwell time, the number of times the spot has been introduced or cited on a media such as TV, magazines, the Internet, and SNS, a mobile body, purchase data, the prices of products or services traded at the spot, categories and types of products or services to generate a cluster, and then take into account them when performing clustering.

With respect to spots, the cluster generating unit 1033a may assign a high value to a significant place, that is, a place with a high rarity. The rarity is assigned a high value when some users undertake common activities. For example, a high rarity may be assigned to a place with a small number of visits. Railway stations, convenience stores, or the like, are assigned a low rarity as being visited by many people. On the other hand, a place with a small number of visits such as a bookstore and a live music venue that are popular with people of specific taste is assigned a high rarity.

Furthermore, for example, a high rarity may be assigned to a place with a large dwell time or a large number of visits per person for a spot. In this connection, a high rarity may be assigned when only some users stay at a certain spot for 60 minutes or more, although the dwell time at the spot is usually within 15 minutes. Specifically, in a case in which most users who utilize a certain railway station utilize there to board a train from the railway station while some users stay there longer to take a picture of a train, users who stay for 60 minutes or more may be classified into a comparable spot A2 that is different from a general spot A to generate clusters. Furthermore, a high rarity may be assigned to a spot or the type of spot at particular date and time. For example, a comparable spot B2 that is different from a general spot B (or a type C2 of the comparable spot that is different from a type C of the general spot) may be defined for each event presented at a certain facility or event venue to generate clusters, and a rarity that is higher than that for the spot B (or the type C of the spot) may be assigned to the spot B2 (or the type C2 of the spot).

Furthermore, for example, a higher rarity may be assigned to a spot with a smaller number of related spots with respect to a certain spot.

When generating clusters, the cluster generating unit 1033a may first select only spots with the rarity exceeding a certain threshold before generating clusters based on the commonality of the spots visited by a user.

When generating clusters, the cluster generating unit 1033a may set a higher score to a cluster that includes a larger number of spots with a high rarity and preferentially generate clusters with higher scores, or may extract a cluster by performing rearrangement in descending order of clusters with higher scores after generating the clusters.

When the cluster generating unit 1033a generates clusters, hierarchical clustering, non-hierarchical clustering, or known clustering algorithms may be used.

When generating clusters, instead of generating a cluster based on common spots, the cluster generating unit 1033a may create a zone in which a number of spots are assembled and generate a cluster based on the zone. At this time, as with a spot, the cluster generating unit 1033a may perform clustering by using information such as location information of a zone, the type or an attribute of a spot belonging to a zone, and the number of visits of a user.

When generating clusters, the cluster generating unit 1033a may limit a range of spots or zones to be classified and generate a cluster based on the spots or the zones within the limited range. The cluster generating unit 1033a may also take a certain time range and generate a cluster within a specified time. At this time, a cluster may be generated based on a range of the days of the week, time windows, or the like.

Furthermore, when generating clusters, the cluster generating unit 1033a may take into consideration the number of visits, the clock time of a visit, and a dwell time for a spot or a zone to generate a cluster.

Clustering based on specific factors such as the commonality of spots makes it possible to grasp characteristics per cluster or spot.

The cluster generating unit 1033a may perform clustering while taking into account an importance calculated by a predetermined method. As an example, the cluster generating unit 1033a calculates an importance-on-that-day It in the area clustering of on-that-day data based on a frequency Ft and a rarity Rt, which are based on the number of visits for the spot visited by each user on that day.

Specifically, clustering may be performed while taking into account the importance-on-that-day It calculated by the expression:

It (importance-on-that-day)=Ft (frequency-on-that-day)×Rt (rarity-on-that-day)

where

Ft=(At/Bt)

Rt=(Ct/Dt)
At: the number of visits of each user on a spot-by-spot basis on that day,
Bt: a total number of visits of each user for all spots on that day,
Ct: a total number of visits of all users for all spots on that day,
Dt: a total number of visits of all users on a spot-by-spot basis on that day.
In this way, the importance of the spot may be evaluated in the clustering.

In the calculation of the importance-on-that-day It, a total dwell time may be used for calculation in place of the number of visits described above. That is, clustering may be performed while taking into account the importance-on-that-day It calculated by the expression, where;
At: a total dwell time of each user on a spot-by-spot basis on that day,
Bt: a total dwell time of each user for all spots on that day,
Ct: a total dwell time of all users for all spots on that day,
Dt: a total dwell time of all users on a spot-by-spot basis on that day.

In the calculation of the importance-on-that-day It, an average dwell time may be used in place of the number of visits described above. That is, clustering may be performed while taking into account the importance-on-that-day It calculated by the expression, where:
At: an average dwell time of each user on a spot-by-spot basis on that day,
Bt: an average dwell time of each user for all spots on that day,
Ct: an average dwell time of all users for all spots on that day,
Dt: an average dwell time of all users on a spot-by-spot basis on that day.

The parameters for calculating the importance-on-that-day It are not limited to the number of visits, a total dwell time, an average dwell time, and the number of visited spots, and any other parameters may be used to calculate the importance-on-that-day It for being factored in the clustering. Note that while in the embodiment, the importance is calculated by the frequency Ft multiplied by the rarity Rt, which is used as a parameter for being factored in the clustering, it may be stated in the specifications that an importance calculated by other expressions is taken into account.

### (1.3.2. Importance Calculating Unit 1033b)

The importance calculating unit 1033b calculates a daily-importance In, which is an importance on daily activities of a user by using the result of area clustering of the on-that-day data by the cluster generating unit 1033a and the daily-location information of the user. For each cluster generated by the cluster generating unit 1033a, the importance calculating unit 1033b acquires the daily-data of a user belonging to the cluster to calculate the daily-importance In on daily activities of the user.

As an example, the daily-importance In is calculated by the following expression:

In (daily-importance)=Fn (daily-frequency)×Rn (daily-rarity)

where

Fn=(An/Bn)

Rn=(Cn/Dn)
An: the number of visits of each user per type of spot in the daily life
Bn: a total number of visits of each user for all types of spots in the daily life
Cn: a total number of visits of all users for all types of spots in the daily life
Dn: a total number of visits of all users per type of spot in the daily life.

Calculating the importance for types of spots as described above makes it possible to bring about a practically calculatable amount of information even when the analysis is made in a vast range such as all over Japan. Note that the daily-importance In is preferably calculated by using the same parameters as those in the importance-on-that-day It. That is, in a case in which the importance-on-that-day It has been calculated by using the number of visits, it is preferable that the daily-importance In is also calculated based on the number of visits, and in a case in which the importance-on-that-day It has been calculated by using any of the total dwell time, the average dwell time, and the number of visited spots, it is preferable that the daily-importance In is also calculated by using any corresponding parameters.

Furthermore, the importance calculating unit 1033b calculates the importance of the type of the spot visited by a user on that day by using the location-on-that-day information of the user.

It (importance-on-that-day)=Ft (frequency-on-that-day)×Rt (rarity-on-that-day)

where

Ft=(At/Bt)

Rt=(Ct/Dt)
At: the number of visits of each user per type of spot on that day,
Bt: a total number of visits of each user for all types of spots on that day,
Ct: a total number of visits of all users for all types of spots on that day,
Dt: a total number of visits of all users per type of spot on that day.

### (1.4. Data Analyzing Unit 1034)

The data analyzing unit 1034 analyzes activities of a user based on the activities-on-that-day data and the daily-activities data generated by the activity data generating unit 1033. As an example, the data analyzing unit 1034 provides a display for comparison between the activities-on-that-day data and the daily-activities data, a recommendation on activities on that day based on the daily-activities data, matching of clusters to which the user belongs based on the daily-activities data, and the like.

### 2. Data Structure

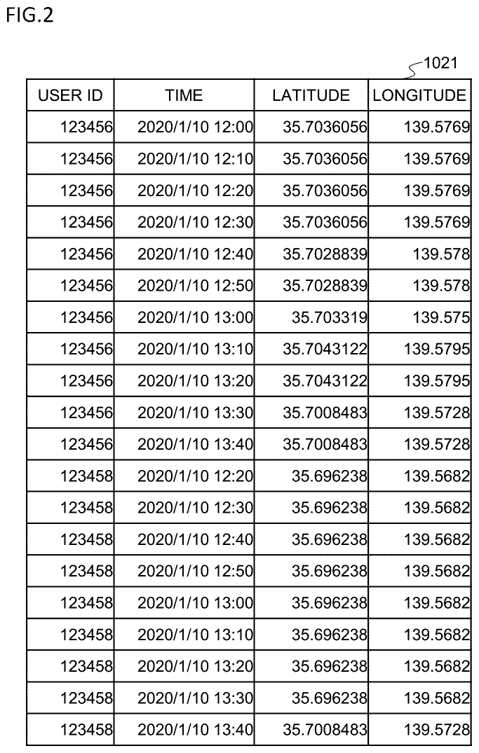

FIG. 2 illustrates a specific example of the user information DB 1021. The user information acquiring unit 1031 acquires location information and time information from the user periodically at a fixed time interval. The user information acquiring unit 1031 then stores the user ID of the user from whom the location information is acquired, the acquisition time, and the location information of the user (latitude and longitude) in the user information DB 1021. Information stored in the user information DB 1021 is not limited to those described above, and any other information such as age (generation), gender, the residential area of the user may be stored.

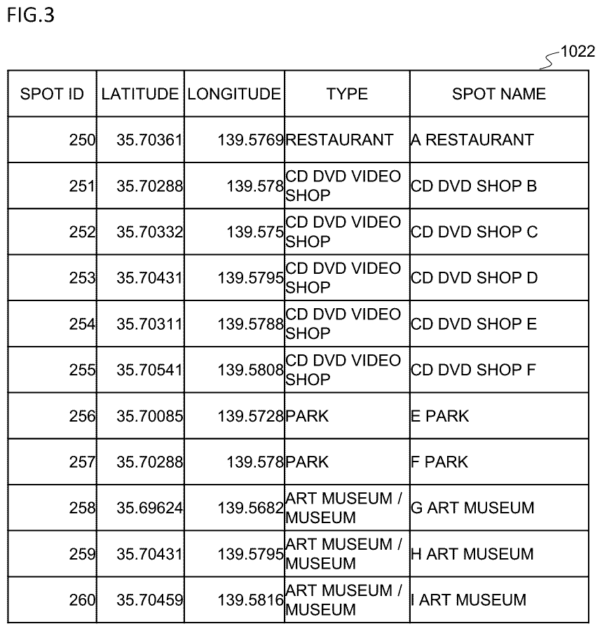

FIG. 3 illustrates a specific example of the spot information DB 1022. The spot information DB 1022 stores an identification (ID) for identifying a spot, location information of a spot (latitude, longitude), a spot name (such as a shop name), a type (categorized based on a use of a spot such as a restaurant, a theme park, and a railway station). In the spot information DB 1022, any other information such as the opening time and an average budget of the spot may also be stored, or a link to the official website of the spot or an introduction page may be saved so that various information on the spot can be obtained.

### 3. Processing Flow

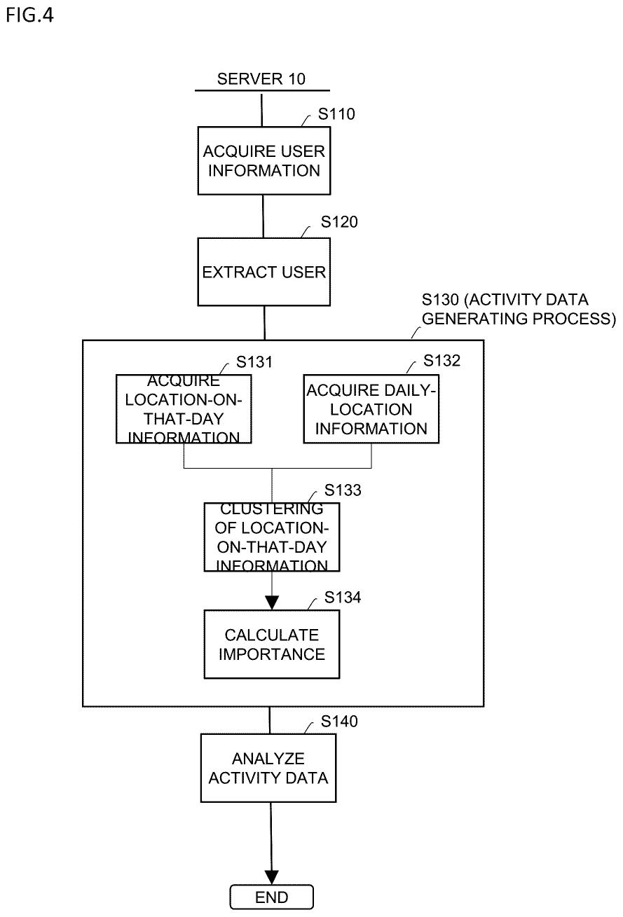

FIG. 4 shows a processing flow of a cluster generating program in the first embodiment of the present disclosure.

### (3.1. Acquiring User Information)

In step S110, the user information acquiring unit 1031 successively acquires location information of a user and time. The user information acquiring unit 1031 then stores the acquired information in the user information DB 1021 sequentially.

### (3.2. Extracting User)

In step S120, the user extracting unit 1032 refers to the user information DB 1021 and the spot information DB 1022 to extract a user who has visited the survey spot during the survey period.

### (3.3. Generating Activity Data)

In step S130 (activity data generating process), the activity data generating unit 1033 generates activity data (the activities-on-that-day data and the daily-activities data) based on the location-on-that-day information and the daily-location information of the user extracted by the user extracting unit 1032. In the activity data generating process, steps S131 to S134 are executed.

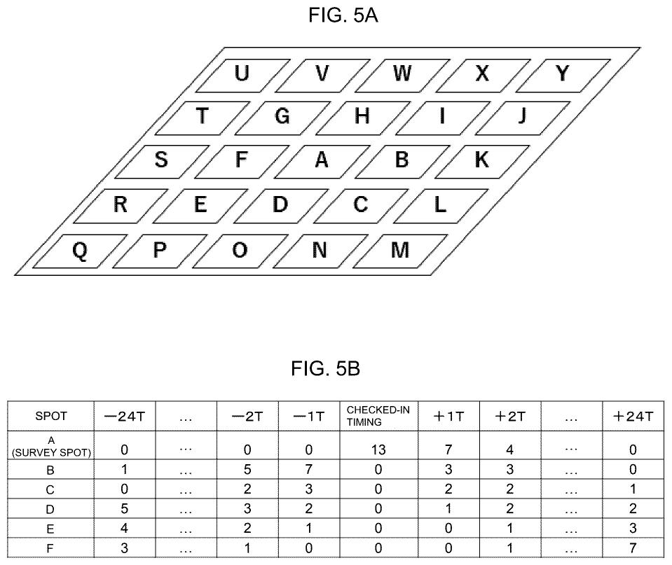

In step S131, the location-on-that-day information is acquired. As illustrated in FIG. 5A, the activity data generating unit 1033 determines whether or not the user has visited the survey spot on a mesh-by-mesh basis, the meshes being defined at a predetermined interval. In FIG. 5A, the meshes are defined at 125 m interval as an example, and the activity data generating unit 1033 determines whether or not a segment A that is the survey spot has been visited.

The activity data generating unit 1033 acquires the location-on-that-day information of the extracted user. Here, when acquiring the location-on-that-day information, the activity data generating unit 1033 detects which area the user visited the survey spot has been during a predetermined period (for example, preceding and subsequent periods every 12 hours) relative to the visiting timing.

In the table illustrated in FIG. 5B, it is indicated that among 13 users who have visited (hereinafter, referred to as “checked in”) the survey spot (segment A) for the first time at a certain day during the survey period, three users have moved to a segment B, two users to a segment C, and one user to a segment D after a unit time T (in the embodiment, as an example, 30 minutes) has passed relative to the checking-in timing. Furthermore, it is indicated that among the 13 users, three users have moved to the segment B, two users to the segment C, two users to the segment D, one user to a segment E, and one user to a segment F after 2T has passed.

On the other hand, it is indicated that among the 13 users, seven users have been in the segment B, three users in the segment C, two users in the segment D, and one user in the segment E a unit time T before the checking-in timing. Furthermore, it is indicated that among the 13 users, five users have been in the segment B, two users in the segment C, three users in the segment D, two users in the segment E, and one user in the segment F, 2T before the checking-in timing.

As described above, in the embodiment, preceding and subsequent 12 hours (i.e. 24-hour period) based on the timing at which the user checked in the survey spot are defined as “that day” to acquire location information of the user. In this way, it is possible to accurately grasp the utilization of the spot in actuality without unduly exposing personal information and acquire sufficient information for being divided in a subsequent clustering process. Furthermore, it is possible to clearly distinguish between data “on that day” and “daily” data. Note that a predetermined period for defining “that day” is not limited to preceding and subsequent 12 hours relative to the checking-in timing and may be set as appropriate. For example, a period of preceding and subsequent three days relative to the checking-in timing may be defined as “that day”.

Furthermore, as described above, acquiring location information during preceding and subsequent periods per a predetermined unit time based on the checking-in timing makes it possible to grasp activities of the user on that day, so that in a subsequent comparison process (step S140) of activity data, it is possible to analyze activities of the user for utilizing as information in providing an appropriate recommendation. Furthermore, clustering can be performed in consideration of a chronological order of activity data of the user on that day.

In step S132, the activity data generating unit 1033 acquires location information (also referred to as the daily-location information) during a survey period (i.e. a period corresponding to “daily”) of the extracted user.

In step S133, the cluster generating unit 1033a performs area clustering based on the location information of the spots visited by the user on the visit day. Based on the spots visited by the user, the cluster generating unit 1033a generates a cluster that is a classification of users. The clusters are generated by using hierarchical clustering, for example, as illustrated below.

In the hierarchical clustering, for example, the commonality of a spot as viewed from a user (the commonality of a user as viewed from a spot) is replaced with a distance or the similarity to perform clustering of spots. Specifically, for example, when there are three spots A, B, and C and IDs of the users who have visited the spots are A=(01, 02, 03, 04, 05), B=(01, 02, 03, 04, 06), and C=(01, 02, 07, 08, 09), respectively, A and B that have high commonalities (high similarities) of users are first subjected to clustering, and thereafter, clustering is performed in the form of A+B, C. As candidates for the hierarchical clustering, patterns of A+B+C, A+B, C, A, and B are generated.

The cluster generating unit 1033a performs the hierarchical clustering while combining similar spots to generate clusters. At this time, it is considered that only a general place such as a railway station or a convenience store has been visited in a cluster with a small number of common spots, which is less distinctive. Accordingly, clusters with a large number of common spots (the number of common users is smaller) may be extracted to generate final clusters.

Furthermore, to select distinctive clusters, the clusters may be rearranged in descending order of values obtained by the number of common spots multiplied by the number of users. In addition, a total sum of dwell times in common spots and the like may be used as an indicator, or otherwise factors for extracting a distinctive cluster may be factored in. Furthermore, top M1 clusters are extracted by using the indicators to assemble clusters.

In the cluster generating unit 1033a, not limited to the hierarchical clustering, clusters may be generated by using non-hierarchical clustering or known clustering algorithms.

The cluster generating unit 1033a may generate a cluster by using a significant place, that is, a rarity. For example, rarity 10 is allocated to a spot visited only by some users (a spot whose number of visiting users is “a” or more and “b” or less) and any other spots are allocated rarity 1. When clusters are to be generated, then the rarity may be calculated from the spots included in a cluster and generated clusters may be rearranged in descending order of those with a high rarity. At this time, M clusters may be extracted in descending order of those with a high rarity.

Furthermore, when the rarity is taken into consideration, not just the number of visits of a user, the rarity may be assigned in consideration of factors such as the clock time of a visit, a dwell time, the commonality of the types of spots, a total dwell time, an average dwell time, the number of times the spot has been introduced or cited on a media such as TV, magazines, the Internet, and SNS, a mobile body, purchase data, the prices of products or services traded at the spot, and categories and types of products or services.

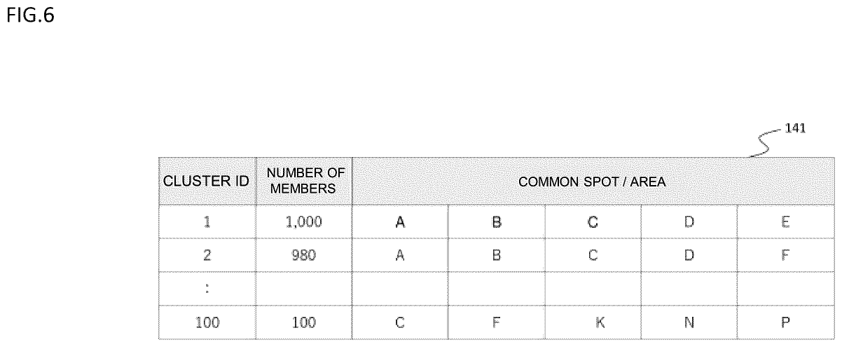

FIG. 6 illustrates a specific example 141 of clusters generated after clustering by the cluster generating unit 1033a. For example, an example is illustrated, in which when the target is to generate 100 clusters, 100 clusters are generated in descending order of those with a large number of common spots and a large number of members.

Not just the commonality of the spots (commonality of the users), the cluster generating unit 1033a may take into account factors such as the clock time of a visit, the number of visits, a dwell time, the commonality of the types of spots for clustering. At this time, the cluster generating unit 1033a may assign weights to factors such as the commonality of the spots (the commonality of the users), the clock time of a visit, the number of visits, a dwell time, the commonality of the types of spots for clustering.

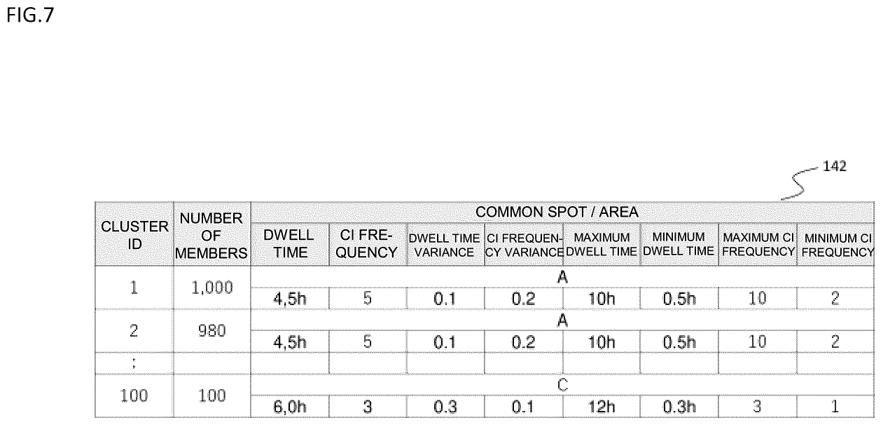

FIG. 7 illustrates a specific example 142 in which clustering is performed taking into account, in addition to the commonality of the spots, (the commonality of the user), a dwell time, a visiting frequency (indicated as CI frequency in FIG. 7), a dwell time variance, a visiting frequency variance, a maximum dwell time, a minimum dwell time, a maximum visiting frequency, and a minimum visiting frequency. Although omitted in FIG. 7, there are actually a plurality of spots in each cluster as in FIG. 6, and for example, in the cluster of cluster ID1 in FIG. 7, not just the spot A, there are spots B, C, D, and E as elements.

In step S134, the importance calculating unit 1033b acquires the daily-data of the user belonging to the cluster for each cluster generated by the cluster generating unit 1033a and calculates a daily-importance In on daily activities of the user.

### (3.4. Analyzing Data)

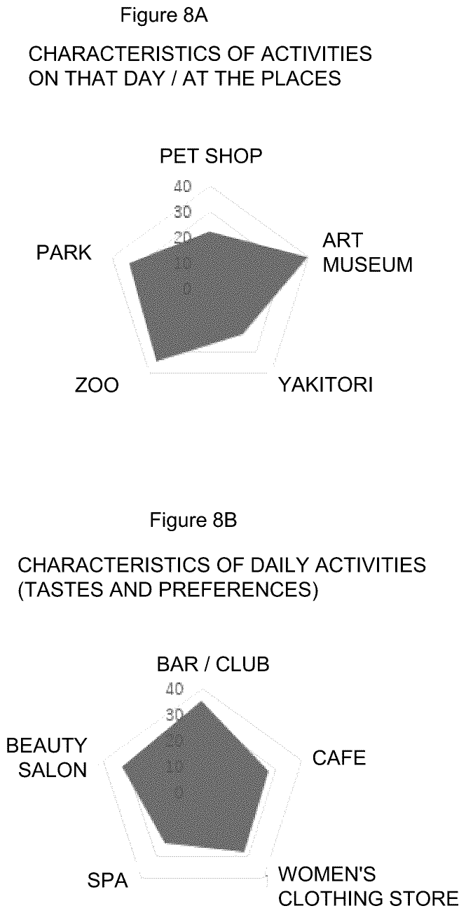

In step S140, the data analyzing unit 1034 compares the activities-on-that-day data (the location-on-that-day information, the result of the area clustering, and the importance-on-that-day It) with the daily-activities data (the daily-location information and the daily-importance In). For example, in examples illustrated in FIG. 8, a radar chart for activities on that day and a radar chart for daily activities are displayed in a contrasted manner. With such a comparison, it is possible to check what activity the extracted user has a preference for undertaking on that day. In addition, it is possible to check what activity the extracted user has a preference for undertaking in the daily life. In this way, it is possible to infer the reason, the necessity, the motivation, or the like for activities on that day.

Furthermore, from the survey spot or the current location of the user and the current clock time, the data analyzing unit 1034 compares parameters (for example, the occupancy of the visited spot, the dwell time, the route, the schedule, and the importance) between activities on that day and daily activities. The data analyzing unit 1034 then calculates separation at or more than a predetermined threshold (or an agreement within a threshold range) between the activities on that day and the daily activities.

Furthermore, it may be stated in the specifications that the data analyzing unit 1034 recommends, to an operator of the server 10, a predetermined spot that is assumed to follow an activity pattern of the user on that day based on the calculated degree of coincidence between activities on that day and daily activities. For example, when the calculated separation between activities on that day and daily activities exceeds a predetermined threshold, a spot that matches a daily activity pattern of the user (which may be the proper name of the spot or the genre of the spot) or contents are presented to the operator.

Furthermore, it may be stated in the specifications that, from activities of the user on that day, the data analyzing unit 1034 performs matching with a cluster that has an agreeable activity pattern and navigates activities on that day. It may be stated in the specifications that daily activities are recommended. Furthermore, it may be stated in the specifications that, from daily activities of the user, the data analyzing unit 1034 performs matching with a cluster that has an agreeable activity pattern and navigates activities on that day, or it may be stated in the specifications that daily activities are recommended.

As described above, in the embodiment, a server 10 executes: a user information acquiring step of acquiring location information of a plurality of users; a user extracting step of extracting, from the location information of the plurality of users, a user who has visited a predetermined spot during a predetermined period; and an activities-on-that-day data generating step of generating, as activities-on-that-day data, data on where the user has been during preceding and subsequent periods per a predetermined unit time relative to a timing when the spot has been visited by the user who has visited the predetermined spot based on the location information of the extracted user.

With such a configuration, it is possible to grasp a service expected by a user who has visited a particular facility or region. Furthermore, according to the needs, it is possible to grasp what service or facility is to be recommended to the user.

The comparison between activities on that day and daily activities makes it possible to analyze how a person who has a particular activity pattern in the daily life has moved on that day or analyze how a person who has moved on that day will act in the daily life, based on which it is possible to recommend or navigate a spot or contents. Furthermore, it is possible to predict activities on that day from a cluster to which the user belongs for daily activities or predict a daily activity pattern from a cluster to which the user belongs for activities on that day.

More specifically, for example, in a case in which the location information is acquired at a frequency of once per hour, 24 pieces of location information can be acquired in one day for one user, 720 pieces of location information can be acquired in one month (30 days), and 8760 pieces of location information can be acquired in one year (365 days). For example, in a case in which a “daily” period is for one year, it is possible by analyzing the daily-activities data and comparing the 8760 pieces of location information with those of other users to determine the preference of what genre (or area) is favored (or disliked).

On the other hand, in a case in which the acquisition of the activities-on-that-day data occurs within preceding and subsequent 12 hours across a reference timing, analyzing the activities-on-that-day data results in comparison of 24 pieces of location information with those of other users. In this case, it is possible to determine a trend of movement on that day.

Furthermore, in the embodiment, only location information of a user is acquired, and any other attribute data (such as taste, preference, purchase history, age, gender, and occupation) needs not to be acquired. Therefore, there are the following advantages:
An analysis results can be rapidly generated based on location information of a large number of users;
A load in data analysis can be reduced;
A large number of attribute respondents can be obtained, so that accurate data analysis can be made;
No need to combine separate data, so that accurate data analysis can be made;
No need to purchase separate data, so that data analysis can be made inexpensively; and
Since it is not a complex generation method that combines various data, the analysis practitioner can easily repurpose the analysis result.

The data analysis of the embodiment can easily be utilized in such a manner that regular observation is performed at a point every month or utilized in such a manner that a nationwide analysis is made for navigation for all regions nationwide.

In view of the circumstance in which the trend is intolerant to retaining personal information, it is expected that the marketing based on statistical data will increase in the future. The data analysis and statistical processing of the embodiment makes it possible to match a user with statistical data from various viewpoints of schedules on the basis of “that day” /“daily” or route/genre, and user preferences.

### 4. Hardware Configuration

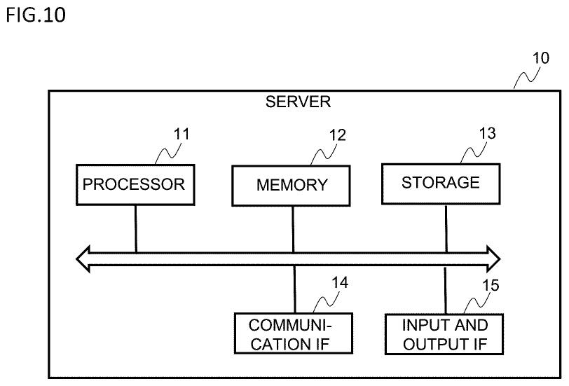

FIG. 10 is a diagram illustrating a hardware configuration of the server 10. The server 10 is a general computer. The server 10 is implemented by, for example, a desktop personal computer (PC), laptop PC, or the like. The server 10 may also be a smartphone, or a computer with portability such as a tablet terminal.

As illustrated in FIG. 10, the server 10 includes a processor 11, a memory 12, a storage 13, a communication IF 14, and an input and output IF 15.

The processor 11 is a hardware for executing an instruction set described in a program and constituted of an arithmetic unit, a register, peripheral circuitry, and the like. The memory 12 is for temporarily storing a program and data or the like that is processed by the program or the like and implemented by, for example, a volatile memory such as a DRAM (Dynamic Random Access Memory). The storage 13 is a storage device for saving data and implemented by, for example, a flash memory and an HDD (Hard Disc Drive). The communication IF 14 is an interface for sending and receiving a signal for the server 10 to communicate with an external device. The input and output IF 15 functions as an interface with an input device for receiving input from a user and an output device for presenting information to the user.

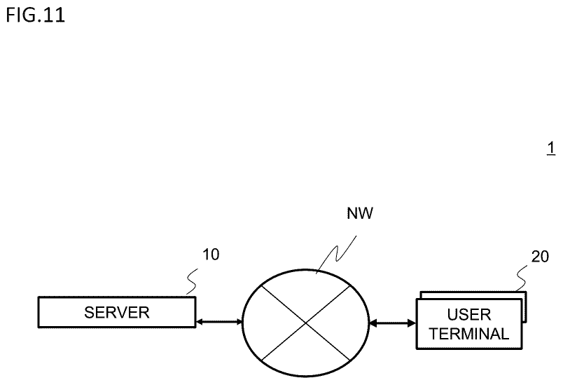

FIG. 11 illustrates an example of a system 1 with the server 10 and the user terminal 20 being connected with each other. In the system 1 according to the present disclosure, as illustrated in FIG. 11, the server 10 and the user terminal 20 may be connected and operated through a network. At this time, functions may be distributed between the server 10 and the user terminal 20. Furthermore, functions may be distributed among a plurality of servers.

The information processing device according to the present disclosure may not necessarily rely on the device and, for example, a computer may execute a program to implement the functions. The program for implementing the functions of the information analyzing device may be stored in a computer-readable recording media such as a USB (Universal Serial Bus) memory, a CD-ROM (Compact Disc-Read Only Memory), a DVD (Digital Versatile Disc), and an HDD (Hard Disc Drive), or may be downloaded to the computer through a network.

### 5. Modification

As a modification, while in the above-described embodiment, in step S131, the acquisition of the location information occurs relative to the checking-in timing at which the survey spot has been visited for the first time, it may occur relative to a timing at which the user has visited and then left the survey spot (hereinafter, referred to as a checking-out timing).

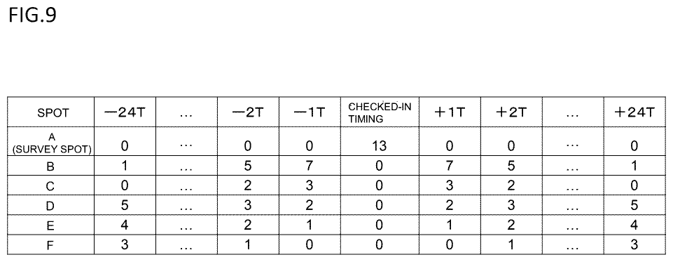

In the table illustrated in FIG. 9, it is indicated that among 13 users who have visited (hereinafter, referred to as “checked in”) the survey spot (segment A) for the first time at a certain day during the survey period, seven users have moved to the segment B, three users to the segment C, two users to the segment D, and one user to the segment E after a unit time T (in the embodiment, as an example, 30 minutes) has passed relative to a checking-out timing at which the user has left the segment A. It is also indicated that among the 13 users, five users have moved to the segment B, two users to the segment C, three users to the segment D, two users to the segment E, and one user to the segment F after 2T has passed.

In this way, acquiring the location information of a user, who has checked in the survey spot, relative to the checking-out makes it possible to accurately grasp a relationship between the survey spot and other spots. That is, it is possible to simply grasp to which spot the user has moved from the survey spot, so that activity data can easily be analyzed in a case in which the survey spot is a spot with a defined utilization time such as a movie theater and a stadium.

### SECOND EMBODIMENT

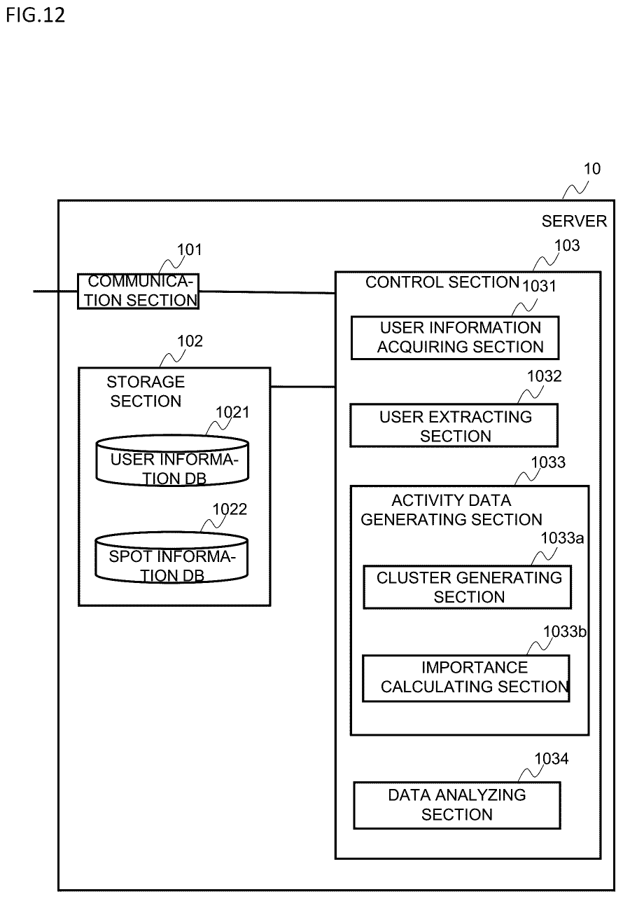

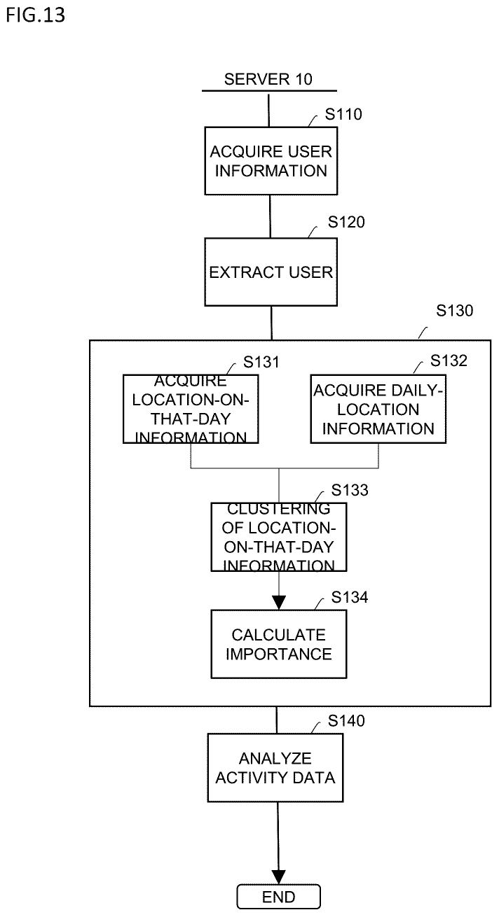

The second embodiment will be described with reference to FIGS. 12 and 13. In the second embodiment, the cluster generating unit 1033a performs clustering based on the daily-location information. Hereinafter, the description will be made mainly about differences.

### 1. Cluster Generating Unit 1033a

The cluster generating unit 1033a in the second embodiment generates a genre cluster that is a classification of users based on the type (genre) of a spot visited daily by a user. Here, the type of spot may specifically be a categorization based on businesses such as restaurants, entertainment facilities, computer shops, and bookstores. Alternatively, not just a categorization based on businesses, the type of spot may be a categorization according to criteria based on services provided as viewed from various aspects, such as the opening day of the spot, the day when the spot has been introduced or registered on SNS (Social Networking Service) or other media, what country the service represents (for example, American style, Italian style), a classification on average customer spend, and public-oriented or niche-oriented.

Based on user information acquired from the user extracting unit 1032, the cluster generating unit 1033a grasps which spot the user has checked in, that is, which spot the user has visited. How the user's visit to the spot is determined by the cluster generating unit 1033a is similar to the first embodiment, and therefore the description will not be repeated.

The cluster generating unit 1033a detects the type of spot from the spots visited by the user and generates a genre cluster that is a classification of users based on the type of the spot visited by the user. The cluster generating unit 1033a generates genre clusters, for example, based on the commonality of the types of the spots visited by the user by using hierarchical clustering, non-hierarchical clustering, known algorithms, or the like. At this time, the cluster generating unit 1033a may define a target number of clusters to be generated as M2 and generate M2 genre clusters in descending order of the number of the types of common spots based on the type of common spots.

When the cluster generating unit 1033a generates genre clusters, hierarchical clustering, non-hierarchical clustering, or known clustering algorithms may be used.

When performing clustering, the cluster generating unit 1033a may take into account, for example, the type of spot and a total dwell time, and perform non-hierarchical clustering according to the similarity. Furthermore, for example, the type of spot, an average dwell time, and the number of visits may be taken into account, and non-hierarchical clustering may be performed according to the similarity.

When performing clustering, the cluster generating unit 1033a may also take into account a total dwell time of the type of spot, the number of visits, the clock time of a visit, the visit date and time, an average dwell time, the commonality of the number of visited spots, or the like to generate genre clusters.

Furthermore, when performing clustering, the cluster generating unit 1033a may take into account factors, with wights being assigned, such as the commonality of the type of spot, a total dwell time of the type of spot, the number of visits, the clock time of a visit, the visit date and time, an average dwell time, the number of visited spots to generate clusters.

With respect to the type of spot, the cluster generating unit 1033a may assign a high value to a significant place, that is, a place with a high rarity. The rarity may be assigned to any significant element with respect to a spot, a user, and an activity of a user, and the like.

For the assignment of a rarity, the cluster generating unit 1033a may assign the rarity to the type of spot depending on whether the number of spots in the survey region is large or small, in other words, disproportion or percentage of the types of spot. For example, a higher rarity may be assigned to the type of a spot whose amount of presence is smaller than the type of a certain spot. Specifically, when convenience stores are 1000 spots and movie theaters are 10 spots, a higher rarity is assigned to the movie theaters whose amount of presence is smaller. That is, a rarity may be assigned, as its value, a reciprocal of the amount of presence of a type of spot in the survey region.

For example, for the type of a certain spot, the cluster generating unit 1033a may take into account a rarity depending on a spot visited. For example, when a movie theater with a high rarity has been visited, 10 points of visit point are assigned, and a movie theater with a low rarity has been visited, 1 point of visit point is assigned. In this way, a rarity may be taken into account.

For the assignment of a rarity, the cluster generating unit 1033a may assign a high value, for example, when a small yet threshold-exceeding number of users, that is, a limited number of users undertake common activities.

For the assignment of a rarity, the cluster generating unit 1033a may assign a rarity, for example, depending on activities of users such as whether the dwell time is long or short, whether the number of visits is large or small, and/or disproportion of the clock time of a visit. For example, a rarity may be assigned to the type of spot many of which have a disproportion in comparison with the type of other spot, or a rarity may be assigned to the type of spot some of which have a disproportion in comparison with the type of other spot.

The cluster generating unit 1033a may also perform clustering while taking into account an importance calculated by a predetermined method. As an example, the cluster generating unit 1033a calculates an importance In in the genre clustering of the daily-location information based on a frequency Fn and a rarity Rn, which are based on the number of visits for the spot visited daily by each user.

Specifically, clustering may be performed while taking into account the daily-importance In calculated by the expression:

In (daily-importance)=Fn (daily-frequency)×Rn (daily-rarity)

where

Fn=(An/Bn)

Rn=(Cn/Dn)
An: the number of visits of each user per type of spot in the daily life
Bn: a total number of visits of each user for all types of spots in the daily life
Cn: a total number of visits of all users for all types of spots in the daily life
Dn: a total number of visits of all users per type of spot in the daily life.
In this way, the importance of the type of spot may be evaluated in the clustering.

In the calculation of the daily-importance In, a total dwell time may be used for calculation in place of the number of visits described above. That is, clustering may be performed while takin into account the daily-importance In calculated by the expression, where:
An: a total dwell time of each user per type of spot in the daily life
Bn: a total dwell time of each user for all types of spots in the daily life
Cn: a total dwell time of all users for all types of spots in the daily life
Dn: a total dwell time of all users per type of spot in the daily life.

In the calculation of the daily-importance In, an average dwell time may be used in place of the number of visits described above. That is, clustering may be performed while taking into account the daily-importance In calculated by the expression, where:
An: an average dwell time of each user per type of spot in the daily life
Bn: an average dwell time of each user for all types of spots in the daily life
Cn: an average dwell time of all users for all types of spots in the daily life
Dn: an average dwell time of all users per type of spot in the daily life.

In the calculation of the daily-importance In, the number of visited spots per type of spot or the like may be used in place of the number of visits described above. That is, clustering may be performed while taking into account the daily-importance In calculated by the expression, where:
An: the number of visited spots of each user per type of spot in the daily life
Bn: a total number of visited spots of each user for all types of spots in the daily life
Cn: a total number of visited spots of all users for all types of spots in the daily life
Dn: a total number of visited spots of all users per type of spot in the daily life.

The parameters for calculating the daily-importance In are not limited to the number of visits, a total dwell time, an average dwell time, and the number of visited spots, and any other parameters may be used to calculate the daily-importance In for being taken into account the clustering.

### 2. Importance Calculating Unit 1033b

The importance calculating unit 1033b calculates an importance-on-that-day It, which is an importance on activities on that day of a user by using the result of the genre clustering of the daily data by the cluster generating unit 1033a and the location-on-that-day information of the user. For each cluster generated by the cluster generating unit 1033a, the importance calculating unit 1033b extracts the on-that-day data of a user belonging to the cluster to calculate the importance-on-that-day It on activities on that day of the user.

As an example, the importance-on-that-day It is calculated by the following expression:

It (importance-on-that-day)=Ft (frequency-on-that-day)×Rt (rarity-on-that-day)

where

Ft=(At/Bt)

Rt=(Ct/Dt)
At: the number of visits of each user per type of spot on that day,
Bt: a total number of visits of each user for all types of spots on that day,
Ct: a total number of visits of all users for all types of spots on that day,
Dt: a total number of visits of all users per type of spot on that day.

Note that the importance-on-that-day It is preferably calculated by using the same parameters as those in the daily-importance In. That is, in a case in which the daily-importance In has been calculated by using the number of visits, it is preferable that importance-on-that-day It is also calculated based on the number of visits, and in a case in which the daily-importance In has been calculated by using any of the total dwell time, the average dwell time, and the number of visited spots, it is preferable that the importance-on-that-day It is also calculated by using any corresponding parameters.

The importance calculating unit 1033b may also calculate the importance of the visited spot by using the location-on-that-day information of a user:

In (importance-on-that-day)=Fn (frequency-on-that-day)×Rn (rarity-on-that-day)

Fn=(An/Bn)

Rn=(Cn/Dn)

where
An: the number of visits of each user on a spot-by-spot basis on that day,
Bn: a total number of visits of each user for all spots on that day,
Cn: a total number of visits of all users for all spots on that day,
Dn: a total number of visits of all users on a spot-by-spot basis on that day.

### 3. Processing Flow

With reference to FIG. 13, a processing flow of the second embodiment will be described mainly about differences from the first embodiment.

In step S133, the cluster generating unit 1033a performs the genre clustering based on information on the type of spot visited daily by a user.

Based on the type of the spot visited by the user, the cluster generating unit 1033a generates a genre cluster that is a classification of users. The clusters are generated by using, for example, any already-known, existing non-hierarchical clustering approach, such as a K-means algorithm and a minimum mean variance. Furthermore, not only non-hierarchical clustering but also a hierarchical clustering approach may be used.

The cluster generating unit 1033a may generate a genre cluster while factoring in a total dwell time, the number of visits, the clock time of a visit, the visit date and time, and an average dwell time of the type of spot, the commonality of the number of visited spots, or the like. Furthermore, the genre cluster may be generated while factoring in percentages of a total dwell time, the number of visits, the clock time of a visit, the visit date and time, an average dwell time, or the like of the type of spot.

The cluster generating unit 1033a may normalize a total dwell time, the number of visits, the clock time of a visit, the visit date and time, an average dwell time or the like of the type of spot, for example, by dividing them by the total thereof to generate a genre cluster. That is, the cluster generating unit 1033a may create a radar chart per user and generate a genre cluster based on the similarity of the radar charts. In this way, generating a genre cluster after the normalization makes it possible to perform clustering, which emphasizes the similarity of radar charts, that is, a waveform, by using a ratio of parameters.

The cluster generating unit 1033a may generate a genre cluster by using a rarity. Specifically, for example, a value obtained by multiplying a frequency, which is obtained by dividing the number of visits of each user per type of spot by a total number of visits of each user for all types of spots, and a rarity, which is obtained by dividing a total number of visits of all users for all types of spots by a total number of visits of all users per type of spot, may be used in place of the number of visits of a certain user for a certain spot in clustering to factor in the rarity.

When the rarity is taken into consideration, not just the number of visits of a user, the rarity may also be assigned in consideration of factors such as percentages of a total dwell time, the clock time of a visit, and an average dwell time.

For example, the cluster generating unit 1033a may define the number of clusters to be generated as K and generate K clusters by non-hierarchical clustering. However, the cluster generating unit 1033a may use not only non-hierarchical clustering but also any other clustering approaches.

For example, when a plurality of types of spot are assigned to a certain facility and when the type of spot cannot be acquired correctly as in such a case in which there are a plurality of facilities near the location information of being visited by the user, the cluster generating unit 1033a may extract only regions with limited types of spot from the regions of interest to solve the problem of inability to correctly grasp the type of spot for generating a genre cluster.

In step S134, the importance calculating unit 1033b acquires the on-that-day data of a user belonging to the cluster for each cluster generated by the cluster generating unit 1033a and calculates the importance-on-that-day It on daily activities of a user.

In step S140, the data analyzing unit 1034 compares the activities-on-that-day data (the location-on-that-day information and importance-on-that-day It) with the daily-activities data (the daily-location information, the result of the genre clustering, and the daily-importance In). Specifically, from the survey spot or the current location and the current clock time of a user, the data analyzing unit 1034 compares parameters (for example, the occupancy of the visited spot, the dwell time, the route, the schedule, and the importance) between activities on that day and daily activities. The data analyzing unit 1034 then calculates separation at or more than a predetermined threshold (or an agreement within a threshold range) between the activities on that day and the daily activities.

Furthermore, it may be stated in the specifications that the data analyzing unit 1034 recommends, to an operator of the server 10, a predetermined spot that is assumed to follow an activity pattern of the user based on the degree of coincidence between calculated activities on that day and daily activities. For example, when the calculated separation between activities on that day and daily activities exceeds a predetermined threshold, a spot that matches a daily activity pattern of the user (which may be the proper name of the spot or the genre of the spot) or contents are presented to the operator.

Furthermore, it may be stated in the specifications that, from daily activities of the user, the data analyzing unit 1034 performs matching with a cluster that has an agreeable activity pattern and navigates activities on that day, or it may be stated in the specifications that daily activities are recommended.

As described above, it is also possible in the server 10 according to the second embodiment to produce similar advantageous effects to the first embodiment.

### 3. THIRD EMBODIMENT

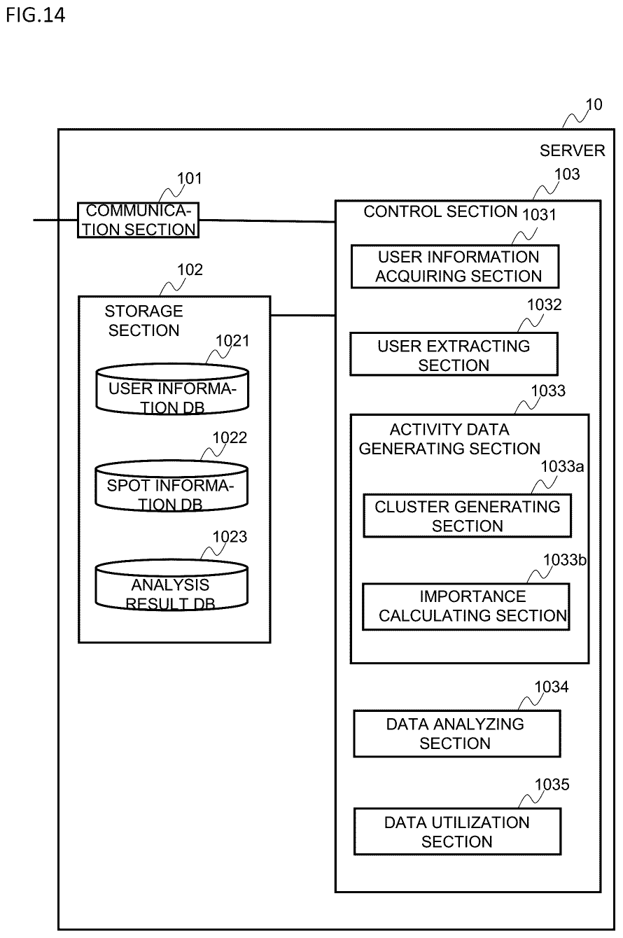

With reference to FIGS. 14 to 17, the third embodiment will be described. As illustrated in FIG. 14, in the third embodiment, the storage unit 102 further includes an analysis result database 1023. Furthermore, the control unit 103 further includes a data utilization unit 1035. In the third embodiment, the data analyzing unit 1034 registers the result of an analyzing process of the activity data (step S140) in the analysis result database 1023. The data utilization unit 1035 refers to the analysis result database 1023 and generates a recommendation on an activity of a user. Hereinafter, the description will be made mainly about differences.

### 1. Data Utilization Unit 1035

The data utilization unit 1035 refers to the result of analyzing process (i.e. the activities-on-that-day data, the daily-activities data, and comparison data of them) stored in the analysis result database 1023 of the storage unit 102 and generates a recommendation on an activity of a user.

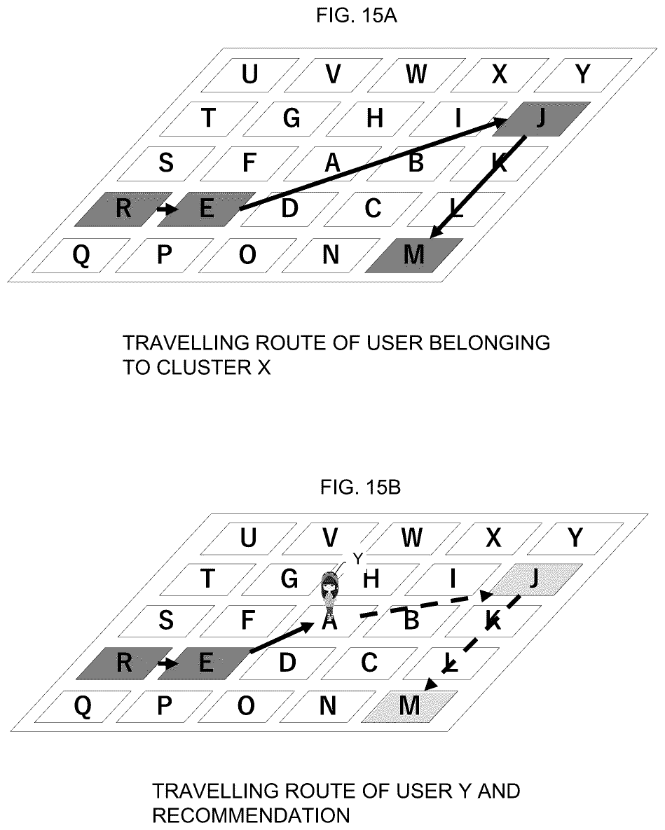

FIG. 15A illustrates a cluster X, which is one of clusters in a clustering result as the activities-on-that-day data of a visiting user. As illustrated in FIG. 15A, the travelling route of the user belonging to the cluster X is from a spot R->a spot E->a spot J->a spot M.

In contrast, a user Y who is a receptor of a recommendation travelled from the spot R->the spot E->a spot A. The data utilization unit 1035 of the server 10 acquires information on the travelling route of the user Y and matches it with the cluster X in which a part of the travelling route agrees.

The data utilization unit 1035 performs matching with the cluster X based on the activities of the user Y and then recommends the travelling route of the cluster X to the user Y. Specifically, while the user Y is travelling from the spot R->the spot E->the spot A, the data utilization unit 1035 recommends the spot J->the spot M. In this way, as an example, the data utilization unit 1035 performs matching with a cluster similar to an activity pattern of a user based on information on the travelling route of the user and makes a recommendation on a spot to be visited based on the travelling route of a user belonging to the cluster.

Note that the matching and recommendation based on a travelling route on that day is only an example and the matching and recommendation may be made based on any other activity data. That is, the activity data stored in the analysis result database 1023 includes the activities-on-that-day data and the daily-activities data. Accordingly, as described above, matching may be performed with a cluster generated by the cluster generating unit 1033a (i.e. matching with the activities-on-that-day data), or matching may be performed with the daily-activities data generated by the importance calculating unit 1033b. Specifically, the data utilization unit 1035 may perform matching with a travelling route of a user based on a travelling route in the daily-activities data.

Furthermore, instead of the travelling route, the matching and recommendation may be made, for example, based on a schedule per genre. In this case, when the schedule per genre of activities on that day (or daily) of the user Y indicates transitioning from a beauty salon->a women's clothing store->a cafe, matching is performed with a cluster that agrees partially or entirely. For example, when a cluster X2 indicates transitioning from the beauty salon->the women's clothing store->the cafe->a park->a bar, the user Y is matched with the cluster X2. Then, a recommendation is made on activities from the park->the bar to the user Y.

Furthermore, instead of the travelling route, the matching and recommendation may be made by accepting an input of tastes and preferences or favorite contents from a user to perform matching with a cluster based on the accepted information. Here, in matching, weights may be assigned as appropriate according to an importance, an occupancy, a dwell time, a frequency, a rarity, a variance, or the like. Furthermore, it may be stated in the specifications that the user is allowed to directly select a cluster and to check a travelling route corresponding to the cluster. For example, it may be stated in the specifications that a plurality of travelling routes classified with a predetermined theme are displayed on a digital signage in front of a railway station at a sightseeing spot and the user is allowed to select a theme (i.e. equivalent to a cluster) to display the travelling route.

### 2. Processing Flow

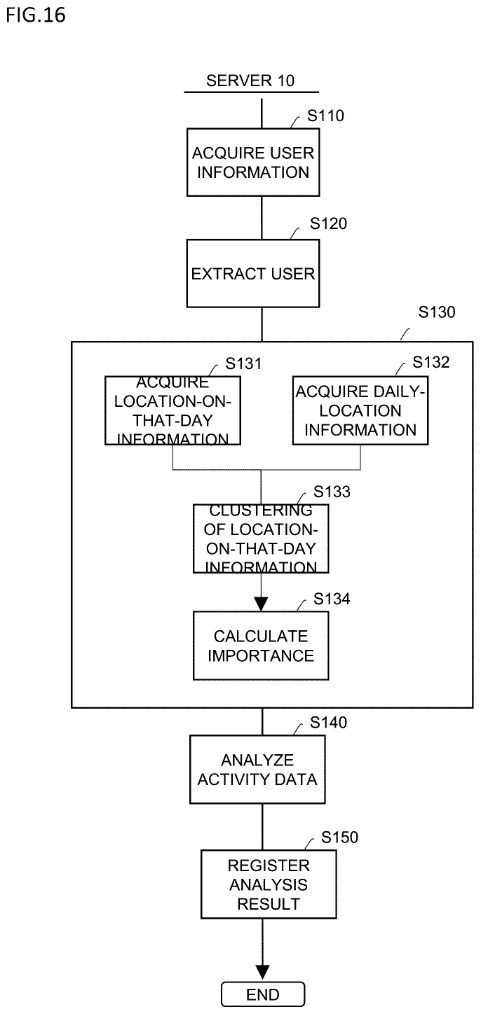

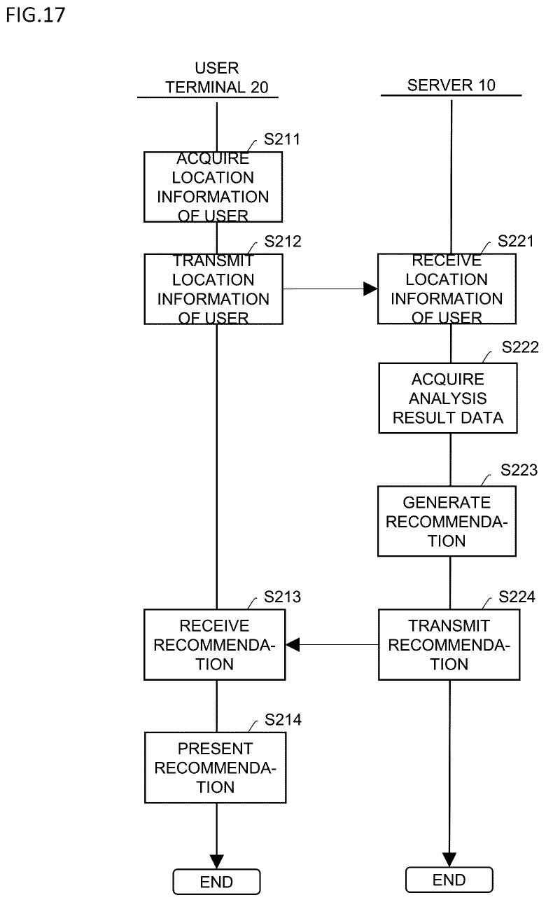

With reference to FIGS. 16 and 17, a processing flow of the third embodiment will be described. Steps S110 to S140 are similar to those in the first embodiment, and therefore the description will not be repeated. In step S150, the data utilization unit 1035 registers the activity data (the activities-on-that-day data and the daily-activities data) generated by the activity data generating unit 1033 and the analysis result generated by the data analyzing unit 1034 in the analysis result database 1023.

In step S211, the user terminal 20 acquires location information of a user. In step S212, the user terminal 20 transmits the location information to the server 10.

In step S221, the communication unit 101 of the server 10 receives the location information of the user. In step S222, the data utilization unit 1035 of the server 10 acquires the activity data and the analysis result data from the analysis result database 1023.

In step S223, the data utilization unit 1035 generates a recommendation. In step S224, the communication unit 101 transmits the recommendation to the user terminal 20.

In step S213, the user terminal 20 receives the recommendation. In step S214, the user terminal 20 presents the recommendation.

As described above, in the third embodiment, the data analyzing unit 1034 registers the result of the analyzing process on the activity data in the analysis result database 1023, and the data utilization unit 1035 refers to the analysis result database 1023 and generates a recommendation on activities of the user. With such specifications, it is possible to utilize the activity data generated by the activity data generating unit 1033 and the result of the data analyzing process performed by the data analyzing unit 1034 for various recommendations along with the preferences of the user.

In the above description, although location information of a user is acquired by the user terminal 20, the aspect is not a limitation. For example, it may be stated in the specifications that the location information acquired by a car navigation system mounted in a vehicle is transmitted to the server 10. Alternatively, it may be stated in the specifications that route information for a user to come to a shop is input in a digital signage (electronic bulletin board) arranged in the shop and the route information is transmitted to the server 10.

### 4. OTHER EMBODIMENTS

Although embodiments to which the technical scope of the application is applied have been described above, the above-described detail is not a limitation.

For example, the method of generating activity data is not limited to the clustering methods described above. That is, area clustering is performed on the location-on-that-day information and genre clustering on the daily-location information in the above-described embodiment. However, the example is not a limitation, and the location-on-that-day information may be subjected to the genre clustering and the daily-location information may be subjected to the area clustering. Furthermore, any other clustering than the area clustering and the genre clustering may be performed.

Furthermore, the activity data generating unit 1033 may generate activity data without clustering. In this case, it is possible to generate various forms of activity data by using grouping according to known statistical approaches based on the location-on-that-day information and the daily-location information of an extracted user.

Furthermore, in the above-described embodiment, the user extracting unit 1032 acquires, as the daily-location information, the location information during the survey period of a user who is extracted due to a visit to the survey spot within the survey period. However, the example is not a limitation. For example, with a predetermined area being set in advance, the user extracting unit 1032 may extract users who have visited a mesh corresponding to the area during a predetermined period and acquire, as the daily-location information, location information during the survey period of a user who has visited the survey spot (or a mesh including the survey spot) within the survey period among the users. In this case, meshes corresponding to specific municipalities (for example, approximately 700 meshes in the case of Musashino city) may be selected as a predetermined area, or meshes corresponding to all over Japan (tens of millions of meshes) may be selected. Note that it is preferable that when the number of meshes are enormous in such a case of all over Japan, the genre clustering is performed instead of the area clustering.

Furthermore, although the survey period is “daily” in the above-described embodiment, the aspect is not a limitation. For example, a period excluding “that day” during the survey period may be defined as “daily”, or it may be stated in the specifications that a period that does not overlap the survey period may otherwise be defined as “daily” to acquire the daily-location information.

Furthermore, when detecting the location information of a user in the above-described embodiment, the user extracting unit 1032 acquires the location information during preceding and subsequent periods per a predetermined unit time relative to the visiting timing when the user who has visited the survey spot to grasp in which area the user has been. However, the aspect is not a limitation. For example, it may be stated in the specifications that the location information is detected at each clock time on the date when the user who has visited the survey spot has checked in. Specifically, for example, it may be stated in the specifications that when the checked-in timing was 10 a.m. on a certain day, the location information is acquired at each clock time (for example, once every hour) from 10 hours before the checked-in timing to 14 hours after the checked-in timing. Furthermore, it may be stated in the specifications that when the checked-in timing was 2 p.m., the location information is acquired at each clock time from 14 hours before the checked-in timing to 10 hours after the checked-in timing. In this case, it may be stated in the specifications that the location information is acquired at the clock time +/−1 hour or +/−2 hours after the checked-in timing (relative clock time), or it may be stated in the specifications that the location information is acquired at the absolute clock time (10 a.m., 13 p.m., or the like).

Furthermore, in the above-described embodiment, the importance-on-that-day It and the daily-importance In are calculated by the expansions described above. However, it may be stated in the specifications that, for example, a TF-IDF value is calculated to use as the importance. Furthermore, clustering may be performed by calculating any other parameters than the importance, or a feature amount of a user may be used. As to how the importance is calculated, the importance may be calculated on visited places per day with the daily- location information of “daily” (for example, one year) being as a whole, or the importance may be calculated on places visited for one year. Furthermore, with the daily-location information of “daily” being as a whole, the importance of date per day may be calculated.

Furthermore, based on the importance on a spot visited by the user on that day and daily calculated by the importance calculating unit 1033b, the cluster generating unit 1033a may perform clustering of spots visited by the user or may perform clustering of dates when the user has acted. For date clustering, for example, the importance of a spot per date where the user has stayed or the type of spot is used to perform clustering per date. In this way, in specific clusters, it is possible to perform date grouping, such as ordinary weekdays when no other characteristic place than work-related places is visited, ordinary holidays when a shopping mall or a park is visited, days of activity relating to a favorite baseball team when a stadium or a sports bar is visited, or days of activity relating to camping when a campsite or a camping equipment store is visited. Such clustering makes it possible to classify a group of specific days when a user belonging to a specific cluster undertakes a specific activity (for example, camping on the next third Saturday), display the classified result on a calendar, or analyze whether a specific date is the day including the “daily” or not the day including the #daily” for the user.

For spot clustering, for example, clustering is performed per spot by using the importance of a spot in the activities-on-that-day data per spot visited by a user or the type of spot. In this way, in specific clusters, it is possible to perform spot grouping, such as a spot visited on ordinary weekdays when no other characteristic place than work-related places is visited, a spot visited on ordinary holidays when a shopping mall or a park is visited, a spot visited on days of activity relating to a favorite baseball team when a stadium or a sports bar is visited, or a spot visited on days of activity relating to camping when a campsite or a camping equipment store is visited. Such clustering makes it possible to classify a group of specific spots where a user belonging to a specific cluster undertakes a specific activity (for example, drinking within a range of 1 km of the stadium or the like), display the classified result on a map, or analyze whether a specific spot is an ordinary spot or an extraordinary spot for the user.

The present invention may be implemented as a computer-readable non-transitory recording media that stores the above-described program. Furthermore, the present invention may be implemented by otherwise obtaining location information of a user acquired by the third party from the user.

Although various embodiments according to the present invention have been described, these are presented by way of example only and are not intended to limit the scope of the invention. Those novel embodiments are susceptible of various other forms, and various omissions, replacements, and alterations may be made thereto without departing from the spirits of the invention. The embodiments and modifications thereof are encompassed by the scope and spirits of the invention and also encompassed by the invention described in the claims and equivalents thereof.

What is claimed is:

1. An apparatus comprising:
processing circuitry configured to:
acquire location information of a plurality of users;
extract, from the location information of the plurality of users, a user who has visited a predetermined spot during a predetermined period; and
generate, as activities-on-that-day data, data on where the user has been during preceding and subsequent periods per a predetermined unit time relative to a timing when the spot has been visited by the user who has visited the predetermined spot based on the location information of the extracted user.

2. The apparatus according to claim 1, wherein in generating the activities-on-that-day data, perform clustering based on information on a spot visited by the user on that day.

3. The apparatus according to claim 2, wherein in generating the activities-on-that-day data, perform clustering in consideration of a chronological order based on location information of the spot visited by the user on that day.

4. The apparatus according to claim 2, wherein the processing circuitry further configured to:
calculate an importance of at least one of a spot visited daily by the user and a type of spot for each cluster generated in the clustering.

5. The apparatus according to claim 1, wherein the processing circuitry further configured to:
generate, as daily-activities data, data on a spot visited by the user during a predetermined daily period based on the location information of the extracted user.

6. The apparatus according to claim 5, wherein in generating the daily-activities data, generate the daily-activities data by using location information of the user that is identical to that used in generating the activities-on-that-day data.

7. The apparatus according to claim 6, wherein in generating the daily-activities data, perform clustering based on information on a spot visited daily by the user.

8. The apparatus according to claim 7, wherein the processing circuitry further configured to:
Calculate an importance of at least one of a spot visited by the user on that day and a type of spot for each cluster generated in the clustering.

9. The apparatus according to claim 5, wherein the processing circuitry further configured to:
compare the activities-on-that-day data and the daily-activities data.

10. The apparatus according to claim 9, wherein in comparing, determine a degree of coincidence between activities on that day and daily activities based on activities-on-that-day data and daily-activities data of the user.

11. The apparatus according to claim 10, wherein the processing circuitry further configured to:
recommend as to a spot or contents assumed to follow an activity pattern of the user based on the degree of coincidence.

12. The apparatus according to claim 9, wherein in comparing the activities-on-that-day data and the daily-activities data, perform clustering of the spot based on importance on a spot visited by the user on that day and daily.

13. The apparatus according to claim 9, wherein in comparing the activities-on-that-day data and the daily-activities data, perform clustering of dates when the user has acted based on importance on a spot.

14. The apparatus according to claim 9, wherein the processing circuitry further configured to:
match with a similar cluster in an activity pattern of another user to an activity of the user daily or on that day based on the result of clustering for the user.

15. The apparatus according to claim 14, wherein the processing circuitry further configured to:
based on the matching, recommend to a matched user as to a spot or contents assumed to follow an activity pattern daily or on that day in a similar cluster.

16. A method performed by a computer,
wherein the computer comprises processing circuitry configured to:
acquire location information of a plurality of users;
extract, from the location information of the plurality of users, a user who has visited a predetermined spot during a predetermined period; and
generate, as activities-on-that-day data, data on where the user has been during preceding and subsequent periods per a predetermined unit time relative to a timing when the spot has been visited by the user who has visited the predetermined spot based on the location information of the extracted user.

17. A system including a computer:
wherein the computer comprises processing circuitry configured to:
acquire location information of a plurality of users;
extract, from the location information of the plurality of users, a user who has visited a predetermined spot during a predetermined period; and
generate, as activities-on-that-day data, data on where the user has been during preceding and subsequent periods per a predetermined unit time relative to a timing when the spot has been visited by the user who has visited the predetermined spot based on the location information of the extracted user.
